(19) United States
(12) Patent Application Publication
(10) Pub. No.: US 2007/0046017 A1
(43) Pub. Date: Mar. 1, 2007

(54) Note Pads Having Magnetic Backing Material and Method of Manufacture

(75) Inventor: Lloyd M. Withers, Syracuse, NY (US)

Correspondence Address: BOND, SCHOENECK & KING, PLLC, ONE LINCOLN CENTER, SYRACUSE, NY, 13202-1355, US

(73) Assignee: P.C.I. PAPER CONVERSIONS, INC., Syracuse, NY (US)

(21) Appl. No.: 11/458,758

(22) Filed: Jul. 20, 2006

Related U.S. Application Data
(60) Provisional application No. 60/713,411, filed on Sep. 1, 2005.

(51) Int. Cl. B42D 3/18

(52) U.S. Cl. 281/51

(57) ABSTRACT

A note pad is disclosed, which has removable sheets and a note pad backer with magnetic properties. Also disclosed is a method of manufacturing note pads having removable sheets and a magnetic note pad backer.

### PRIORITY CLAIM

This application claims priority to U.S. Provisional Patent Application No. 60/713,411, filed Sep. 1, 2005.

### FIELD OF THE INVENTION

This invention relates to a note pad having a backing board with intrinsic magnetic properties and a method of manufacturing such a note pad.

### BACKGROUND OF THE INVENTION

Magnets of various forms are regularly attached to note pads for mounting said pads to perpendicular surfaces capable of magnetic adhesion. When a pad is magnetically mounted, a user can more readily remove one or more of the note pad leaves. Mounting pads to magnetic surfaces also frees work spaces such as table tops, counters and desks of clutter. Magnets also provide a clean and easy mounting method as opposed to adhesives and the like which may not hold adequately or conversely, hold too well and either leave undesirable residue upon removal or damage the mounting surface.

Typically, magnets have been attached to note pads by adhesively bonding a magnet to the stiff cardboard backing board commonly found as the base of many note pads. This backing board supplies rigidity and form to the note pad and provides a receptive surface for magnet mounting. The process of attaching the magnet typically uses adhesive that is applied directly to the backing board and a magnet that is subsequently applied. Alternatively, a magnet material with pre-applied adhesive and a releasable liner material may be laminated to the backing board after removing the liner. Both of these conventional processes involve additional steps that consume extra time and require additional materials to produce magnet-backed note pads.

Conventional magnet-backed note pads typically have a thicker backing that consists of the conventional backing board and an additional layer of magnetic material. In addition, the magnetic material attached to the backing board typically consists of one or more pieces that are smaller than the backing board. This difference in size between the backing board and the attached magnet causes the backing board and the back surface of the note pad to be uneven and creates a space between the backing board and the surface on which the note pad is mounted. The unevenness may make it more difficult to write legibly on the note pad and may produce an aesthetically unpleasing appearance. The space between the backing board and the mounting surface increases the likelihood that the note pad will unintentionally be dislodged from the mounting surface.

A further problem with conventional magnetic note pads is that the note pads and their backing boards, being made of paper, cardboard or other similar material, are susceptible to changes in ambient humidity. This can cause the pad and/or its backing board to curl, which makes the note pads aesthetically unpleasing and increases the likelihood that they will be dislodged from their mounting surface. Because conventional magnetic note pads typically have magnets that are smaller than the backing board, the magnets are not effective to counteract the curling of the backing board and/or the note pad.

### SUMMARY OF THE INVENTION

The present invention addresses the problems of the traditional methods by replacing the traditional cardboard backing board with a thinner and planar magnetic sheet. The use of a magnetic sheet as a backing board eliminates the additional operations and material required to attach magnets to a conventional note pad and thus saves time and materials. In addition, the entire backing board area is magnetized, making it possible to accommodate the mounting of larger pads without the need to use stronger, heavier and/or additional individual magnets that disrupt the desired flat profile of the note pad. Because the entire backing board of the present invention is magnetic, there are no gaps between the backing board and the mounting surface. Furthermore, the magnetic attraction is uniform across the backing board, which counteracts the tendency of the note pad to curl. This also decreases the likelihood that the note pad will be dislodged from the surface to which it is magnetically affixed.

### BRIEF DESCRIPTION OF THE DRAWINGS

FIG. 1 is a side view of a magnetic note pad according to the present invention.

FIG. 2 is a side view of a magnetic note pad according to another embodiment of the present invention, in which the pad's leaves have repositionable adhesive.

FIG. 3 is a detailed side view of a portion of FIG. 2, showing the repositionable adhesive.

### DETAILED DESCRIPTION OF THE INVENTION

Reference will now be made in detail to the present exemplary embodiments of the invention, examples of which are illustrated in the accompanying drawings. Wherever possible, the same reference numbers will be used throughout the drawings to refer to the same or like parts.

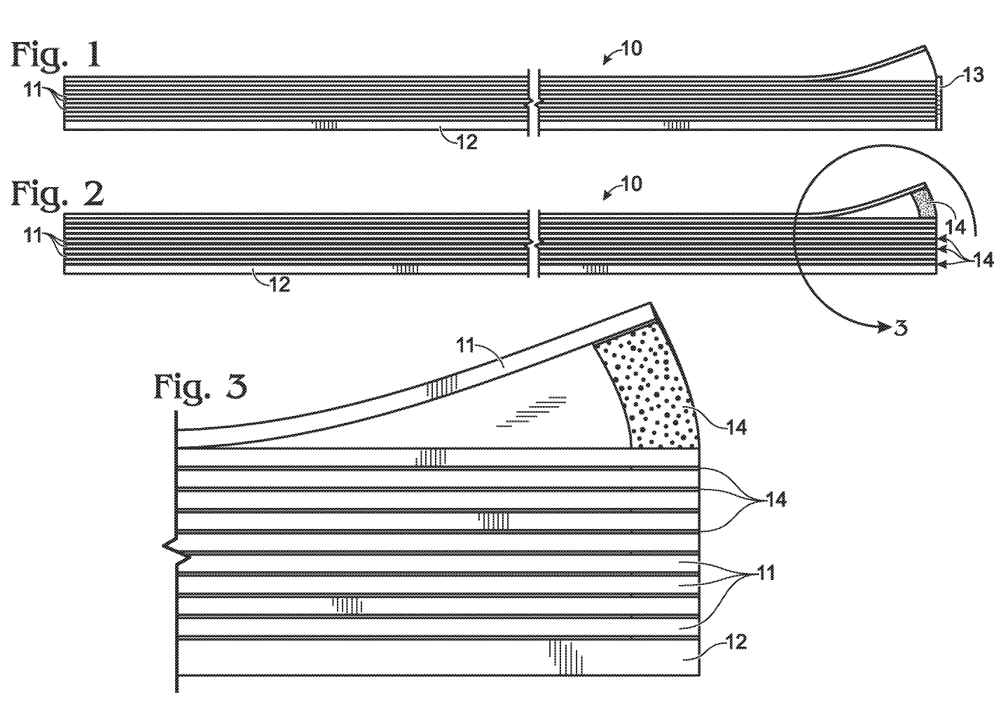

Referring now to FIG. 1, there is shown a magnetic note pad 10 according to the present invention, comprising a plurality of leaves 11 attached to a magnetic note pad backer 12. The leaves 11 may consist of paper, cellulose or other similarly flexible material typically provided in leaf or sheet form. The leaves 11 and the pad backer 12 may have the same shape. That is, the perimeter dimensions of each leaf 11 are the same as the perimeter dimensions of the note pad backer 12. In one alternate embodiment, the perimeter dimensions of the note pad backer 12 are the same as the perimeter dimensions of the leaf 11 adjacent to the note pad backer 12 and the shape of other individual leaves 11 in the note pad 10 may be varied to produce a note pad 10 having a distinctive shape.

The magnetic note pad backer 12 consists of any flexible material that exhibits magnetic attraction or can be treated to exhibit magnetic attraction. Preferably, the magnetic note pad backer 12 is flexible vinyl sheeting which contains magnetic material such as ferrite. The preferred thickness of the magnetic note pad backer 12 is 0.015 inches, but the thickness may vary from application to application. For example, large size note pads 10 or note pads 10 with a large number of leaves may require a thicker note pad backer 12.

According to one embodiment, the leaves 11 are non-adhesive and are attached to the pad backer by means of an adhesive that forms a spine 13 along a first edge of the note pad backer 12 and a first edge of each leaf 11.

Referring now to FIGS. 2 and 3, according to another embodiment each leaf 11 includes repositionable adhesive 14 on a portion of its rear surface such that individual leaves 11 can be removed from the note pad 10 and can selectively be affixed to a surface by means of the repositionable adhesive 14. According to this embodiment, the leaves 11 are attached to each other and to the note pad backer 12 by means of the repositionable adhesive on each leaf's rear surface. If desired, such note pads 10 also can include an adhesive spine 13 as disclosed above.

Magnetic note pads 10 according to the present invention are manufactured by assembling a plurality of leaf sheets 11, consisting of paper, cellulose or other note pad material, in co-extensive and overlaying relationship to each other. Such leaf sheets 11 may undergo pre-assembly processing, for example, by printing indicia patterns on the sheets 11 or selectively applying release coats and repositionable adhesive to the surfaces of the leaf sheets 11, as is known in the art. The assembled leaf sheets 11 are positioned in co-extensive and overlaying relationship to a note pad backer sheet 12.

The assembled leaf sheets 11 and note pad backer sheet 12 may then be cut to size and/or shaped using methods known in the art. Following assembly of the leaf sheets 11 and note pad backer sheet 12 and after cutting to size or shaping, if necessary, adhesive material may be applied to a first end of the assembled leaf sheets 11 and note pad backer sheet 12 to form an adhesive spine 13.

Note pad backer sheets 12 are available in magnetized form or in a non-magnetized form. Note pad backer sheets 12 that are provided in a non-magnetized form must be passed through a magnetizer to activate the magnetic properties of the note pad backer sheets 12. As is known in the art, a magnetizer is a strong magnet that is capable of orienting the magnetic polarity of the magnetic particles in the note pad backer sheet 12. The step of magnetizing the note pad backer sheets 12 can take place at any stage of the manufacturing process, but preferably takes place after the assembled leaf sheets 11 and note pad backer sheet 12 have been cut to size and/or shaped and after an adhesive spine 13 (if any) has been applied.

What is claimed is:

1. A magnetically attachable note pad, comprising:
a sheet attached to a flexible backer, said flexible backer having magnetic properties.

2. The note pad of claim 1 wherein said sheet is attached using repositionable adhesive.

3. The note pad of claim 1 wherein said sheet is attached using a spine of adhesive material.

4. The note pad of claim 1 wherein said flexible backer is comprised of polymeric material.

5. The note pad of claim 4 wherein said polymeric material contains embedded magnetic particles.

6. The note pad of claim 5 wherein said magnetic particles are ferrite particles.

7. A magnetically attachable note pad of selectively detachable pages, comprising:
a plurality of pages of material for receiving or displaying indicia;
a flexible backer comprised of magnetic particles embedded in polymeric material; and
adhesive for temporarily attaching said pages to each other in a generally overlying relationship and for attaching one of said plurality of sheets to said flexible backer.

8. The magnetically attachable note pad of claim 7 wherein said adhesive comprises repositionable adhesive applied to a portion of one side of said pages.

9. A method of manufacturing a magnetically attachable note pad, comprising the steps of:
providing a sheet of flexible backing material containing magnetic particles evenly distributed throughout the sheet;
stacking a plurality of note pad sheets in overlying relationship to each other and to the sheet of flexible backing material to form a pad assembly;
applying adhesive to adhere said note pad sheets to each other and to said sheet of flexible backing material, to form a pad assembly.

10. The method of claim 9 further comprising the step of cutting the pad assembly to a selected size.

11. The method of claim 9 further comprising the step of cutting the pad assembly to a selected shape.

12. The method of claim 9 further comprising the step of exposing the flexible backing material to a strong magnet.
